(19) United States
(12) Patent Application Publication
(10) Pub. No.: US 2026/0176903 A1
(43) Pub. Date: Jun. 25, 2026

(54) MONITORING SYSTEM FOR AN OVERHEAD DOOR ARRANGEMENT

(71) Applicant: Assa Abloy Entrance Systems AB, Landskrona (SE)

(72) Inventors: Lambertus VAN DEN HAZEL, Putten (NL); Mathias BUCHHAAS, Barneveld (DE)

(21) Appl. No.: 19/126,160

(22) PCT Filed: Nov. 4, 2023
(86) PCT No.: PCT/EP2023/082971

§ 371 Date: Apr. 30, 2025

(30) Foreign Application Priority Data
Nov. 28, 2022 (SE) 2230387-9

(51) Int. Cl. E05F 15/40; E05D 13/00; E05F 15/00; E05F 15/60; E05F 15/632; E05F 15/77

(52) U.S. Cl. CPC E05D 13/1269; E05F 15/41; E05F 15/668; E05F 15/77

(57) ABSTRACT

A monitoring system (100) for an overhead door arrangement (10), wherein the overhead door arrangement (10) comprises a door leaf (11), comprising a plurality of door panels (17a-f), being movable between a vertical closed position and a horizontal, opened or overhead position within a side frame (16), wherein the movement is caused by an operating system (20) comprising at least one motor (28) and a drive arrangement (25) connected to the motor (28) and at least one of the door panels (17a-f), and wherein the door leaf (11) is balanced by means of a counter balancing mechanism (70) connected to the door leaf (11) and comprising a balancing shaft (73) and one or more balancing springs (71, 72).

### TECHNICAL FIELD

The present invention relates to the technical field of overhead door systems. More specifically, the present invention relates to a monitoring system for an overhead door arrangement.

### BACKGROUND

Overhead doors today usually have a gear motor connected to a shaft for driving the door leaf. In overhead doors, a counterbalancing mechanism is usually used to counterbalance the weight of the door in order to reduce the force required for operating the door. This reduces the human effort or the motor power required to open the door. The counterbalancing mechanism usually comprises one or two balancing springs arranged around a shaft. There are also variants implementing more than two balancing springs.

The number of turns of the shaft (which are indicative of the door position) are usually measured with a single or multi-turn encoder that is positioned either on the rotor of the electrical motor or on a steering wheel in the gearbox. The encoder and gear motor are connected with a control unit that controls the motor and supervises the needed forces.

Based on the current that the electrical motor is consuming in combination with the position obtained by the encoder, it may be identified how much force is required to move the door leaf at different positions (the force required for the movement may differ depending on how the door leaf is positioned).

The required force may change due to changes in the environmental conditions such as temperature, humidity etc. as well as due to wear and tear and aging of the balancing springs of the counterbalancing mechanism.

The present inventors have realized that the manufacturing tolerances of the gear box and the electrical motor of the gear motor may make monitoring of the counterbalancing mechanism by using the current and the encoder data imprecise and unreliable in some instances.

Thus, there exists a need for an improved manner of monitoring a counterbalancing mechanism.

### SUMMARY

According to an aspect, a monitoring system for an overhead door arrangement is provided. The overhead door arrangement comprises a door leaf comprising a plurality of door panels being movable between a vertical closed position and a horizontal opened or overhead position within a side frame. The movement is caused by an operating system. The operating system comprises at least one motor and a drive arrangement connected to the motor and at least one of the door panels.

The door leaf is balanced by means of a counter balancing mechanism connected to the door leaf and comprising a balancing shaft and one or more balancing springs.

The monitoring system comprises a controller and a load sensing device. The load sensing device is configured to acquire load data associated with the counterbalancing torque provided by the counter balancing mechanism. The controller is configured to obtain said load data.

According to an aspect, an overhead door system is provided.

The overhead door system comprises an overhead door arrangement. The overhead door arrangement comprises a door leaf comprising a plurality of door panels being movable between a vertical closed position and a horizontal, opened or overhead position within a side frame. The overhead door arrangement comprises an operating system, wherein the movement is caused by the operating system comprising at least one motor and a drive arrangement connected to the motor and at least one of the door panels.

The overhead door arrangement further comprises a counter balancing mechanism. The door leaf is balanced by means of the counter balancing mechanism. The counter balancing mechanism is connected to the door leaf and comprises a balancing shaft and one or more balancing springs.

The overhead door system further comprises a monitoring system. The monitoring system may be a monitoring system according to the above-described aspect.

According to an aspect, a method for operating an overhead door system is provided.

The overhead door system comprises an overhead door arrangement. The overhead door arrangement comprises a door leaf comprising a plurality of door panels being movable between a vertical closed position and a horizontal, opened or overhead position within a side frame. The overhead door arrangement further comprises an operating system. The movement is caused by the operating system comprising at least one motor and a drive arrangement connected to the motor and at least one of the door panels.

The overhead door arrangement further comprises a counter balancing mechanism. The door leaf is balanced by means of the counter balancing mechanism and said counter balancing mechanism is connected to the door leaf and comprises a balancing shaft and one or more balancing springs.

The overhead door system further comprises a monitoring system. The monitoring system comprises a controller and a load sensing device. The load sensing device is operatively connected to the controller and configured to acquire load data associated with the counterbalancing torque provided by the counterbalancing mechanism. The controller is configured to obtain said load data.

The method comprises acquiring load data associated with the counterbalancing torque provided by the counterbalancing mechanism and causing operation of the overhead door arrangement based on said load data.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

Embodiments of the invention will be described in the following; reference being made appended drawings which illustrate non-limiting examples of how the inventive concept can be reduced into practice.

FIG. 1 depicts a schematic side view of an overhead door arrangement according to one embodiment.

FIG. 2 depicts a perspective view of an overhead door arrangement according to one embodiment.

FIG. 3 depicts a schematic view of an overhead door system according to one embodiment.

FIG. 4a depicts a perspective view of a counter balancing mechanism of an overhead door arrangement according to one embodiment.

FIG. 4b depicts a more detailed view of a part of the counterbalancing mechanism of FIG. 4b.

FIG. 5a depicts a flow-chart for a method of operating an overhead door system according to one embodiment.

FIG. 5b depicts a flow-chart for a method for operating an overhead door system according to one embodiment.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the detailed description of the particular embodiments illustrated in the accompanying drawings is not intended to be limiting of the invention. In the drawings, like numbers refer to like elements.

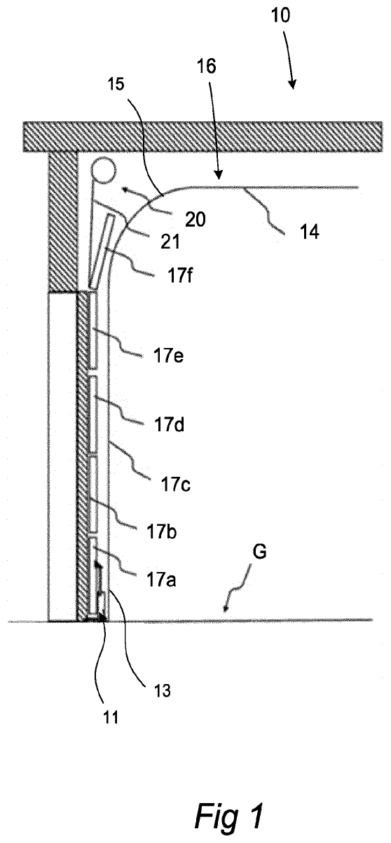

The present invention relates to a monitoring system and an overhead door system comprising such a monitoring system. The overhead door system further comprises an overhead door arrangement. FIG. 1 shows a side view of an illustrative embodiment of an overhead door arrangement according to one embodiment. The overhead door arrangement 10 has a door leaf 11 for covering a door opening in a wall, running in a side frame.

In one embodiment, the door leaf 11 covers a door opening surrounded double-sided by the side frame 16, the wall and by a ceiling above. The side frame has double-sided a vertical track 13, provided as a guiding element on the left and on the right side of the door leaf 11, respectively. Further, the side frame 16 has double-sided a horizontal track 14. The horizontal track 14 runs transversely, in this execution example perpendicular to the vertical track 13, extending rearward to the door leaf 11. A connecting portion 15 with a curved shape connects the vertical track 16 and the horizontal track 14, providing a guideway. The horizontal tracks 14 of the side frame 16 are fixed at a rear side under the ceiling. At a front side the horizontal tracks 14 are fixed at the vertical tracks 13 of the side frame 16, respectively. Accordingly, the overhead door arrangement comprises a pair of vertical tracks 13 and a pair of horizontal tracks 14 connected by a pair of connecting track portions 15. Guiding arrangements may be attached to the door leaf 11 for interfacing with the tracks.

The door leaf 11 is movable between a vertical closed position and a horizontal, opened or overhead position within the side frame. Hence, the door leaf 11 may be movable between a vertical closed position and a horizontal position and/or between a vertical closed position and an opened position and/or between a vertical closed position and an overhead position.

An overhead position herein refers to a position where the door leaf 11 is lifted up from the ground. In the overhead position, the door leaf 11 may for example be vertically arranged or inclined.

The overhead sectional door comprises a plurality of door panel sections 17a-f. The door panel sections 17a-f are arranged to be moved a distance in an upward or downward direction with respect to the ground level G. The door panel sections 17a-f are preferably connected to each other by hinges.

FIG. 1 illustrates an embodiment where five door panels in total 17a-f have been arranged to the doorframe, however, as understood by a person skilled in the art the number of door panels may vary.

The panels 17a-f are preferably consisting of a rigid material. The height of the panels 17 may be between 150 and 1000 millimeters. The height of the panel may for example vary from 400 millimeters from 675 millimeters, making it possible to suit the door's style to that of the building. As the skilled person recognizes, the panels may be of any size and material suitable for the application of the overhead door arrangement. The door panels 17a-f are operated by an operating system 20.

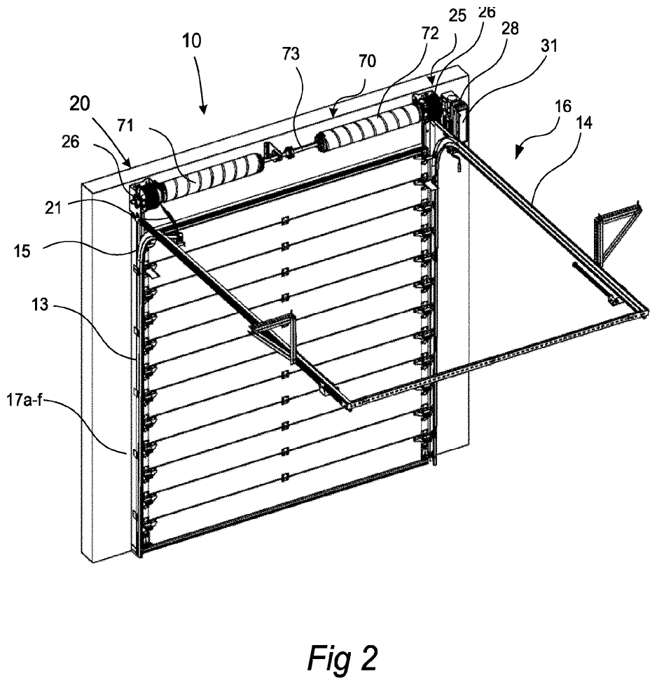

Referencing FIG. 2, an overhead door arrangement 10 according to one embodiment is depicted in further detail.

The operating system 28 may comprise at least one motor 28. The operating system 28 may further comprise a drive arrangement 25. The drive arrangement 25 may be connected to the motor 28. The drive arrangement 25 may further be connected to at least one of the door panels 17a-f.

In the depicted example, the drive arrangement 25 comprises one or more cable drums 26 driven by means of the at least one motor 28. The drive arrangement 25 further comprises one or more cable 21. The one or more cable 21 is connected to the door leaf, e.g. at one of the door panels 17a-f. The one or more cable 21 is preferably made in steel. Thus each cable drum 26 is connected to a cable 21 for winding and unwind the cable 21 to cause movement of the door leaf 11.

The operating system 20 may comprise a D-hoist, T-hoist or U-hoist system. The operating system 20 is preferably arranged on the top or the end of the side frame 16.

It may also be envisioned that the drive arrangement 25 comprises a movable arm connected to the door leaf 11, i.e. at least one of the door panels 17a-f. The movable arm may further be connected to the motor 28 for moving the movable arm and thereby cause movement of the door leaf 11.

In the depicted embodiment, a shaft connected to the motor 28 has a cable drum on each end from which cables 21 run to the bottom corners of the door leaf 17a. When the shaft is turned, the door moves up or down.

The one or more cable 21 may connect to at least one of the panels 17. Thereby the cable works as a lifting device. Further, one cable may connect end pieces of the panels 17 on both sides of the panels 17, respectively. The cable may run in vertical direction in a slot on both sides of the vertical track 16 of the side frame, respectively.

In one embodiment, the motor 28 may be connected to a gear box 31 for transferring torque from the motor 28 to the drive arrangement 25. Hence, the motor 28 may be connected to the gear box 31 for transferring torque from the motor 28 to the cable drum(s).

In one embodiment the cable is only connected to the bottommost panel 17a of the door leaf 11. Hence the door leaf is lifted by means of the cable working as a lifting device for lifting the bottommost panel of the door leaf 11 and consequently lifting the entire door leaf by means of the lifting force applied to said bottommost panel.

Further referencing FIG. 2, the door leaf 11 may be balanced by means of a counter balancing mechanism 70. The counter balancing mechanism may be connected to the door leaf 11. The counterbalancing mechanism may comprise a balancing shaft 73 and one or more balancing springs 71, 72.

Counterbalancing mechanism are well-known in the prior art. As the skilled person is aware, the counterbalancing mechanism 70 is adapted to provide a torque to the door leaf 11 for biasing the door leaf 11 towards the horizontal, opened or overhead position within the side frame 16. Thus, the counterbalancing mechanism 70 is adapted to reduce the speed of the door leaf 11 when the door leaf 11 is moving towards the vertical closed position and assist the movement of the door leaf 11 when the door leaf 11 is moving towards the horizontal, opened or overhead position.

Thus, the balancing shaft 73 may be connected to the door leaf 11. The balancing shaft 73 may be biased by means of the one or more balancing springs 71, 72. The one or more balancing springs 71, 72 may be adapted to bias the balancing shaft 73 to provide a torque for assisting movement of the door leaf 11 towards the horizontal, opened or overhead position within the side frame 16 and/or a torque for deaccelerating movement of the door leaf 11 towards the vertical closed position within the side frame 16. The one or more balancing springs 71, 72 may be torsion springs.

Counter balancing mechanisms are subject to wear due to use of the overhead door arrangement as well as external conditions. Hence, counter balancing mechanisms may require tensioning in order for it to provide proper assistance to the operation of the door leaf and prevention of the door leaf moving to rapidly towards the vertical closed position. Furthermore, in some cases the counter balancing mechanism may be incorrectly tensioned from the initial installation of the door system.

The inventors has realized that there is room for improvement for enabling detection of an improperly tensioned counter balancing mechanism.

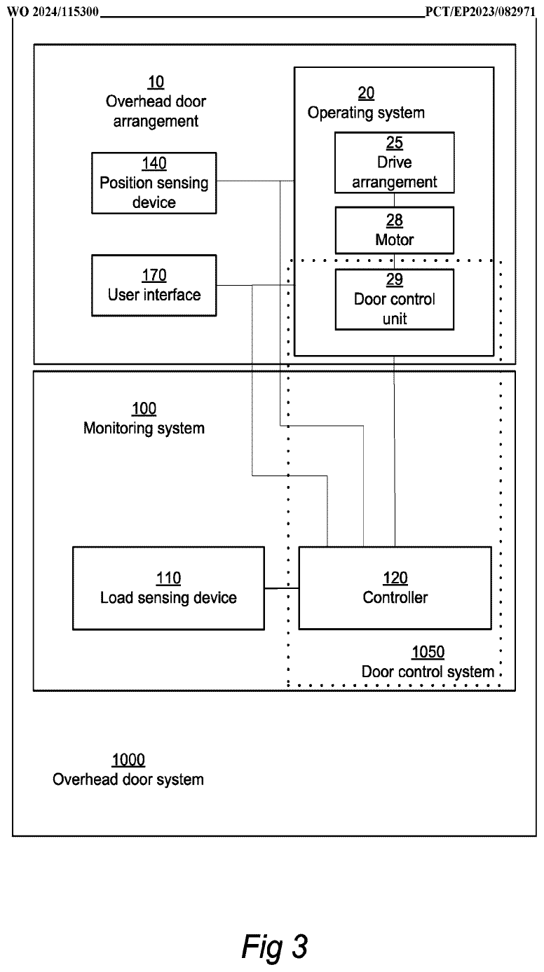

FIG. 3 depicts a schematic view of a monitoring system according to an embodiment.

The monitoring system 100 is intended for an overhead door arrangement 10. The monitoring system 100 may be intended for an overhead door arrangement 10 in accordance with the embodiments of FIGS. 1-2.

The monitoring system 100 may comprise a controller 120 and a load sensing device 110. The load sensing device 110 is operatively connected to the controller 120. The load sensing device 110 is configured to acquire load data associated with the counterbalancing torque provided by the counterbalancing mechanism. The controller 120 is configured to obtain the load data, i.e. the load data associated with the counterbalancing torque provided by the counterbalancing mechanism.

The torque provided by the counter balancing mechanism may be considered as the torque provided by means of the counter balancing shaft and correlates to the tension of the one or more balancing springs. The load data may thus be associated with the tension of the one or more balancing springs.

The load sensing device allows for a more exact measurement compared to other means of detecting the counterbalancing torque since it may monitor the torque independently of the motor and the gear box of the overhead door arrangement, thereby providing a more precise manner of monitoring the counter balancing torque.

The load sensing device 110 may be configured to monitor the torque exerted by the balancing shaft 73. The load sensing device 110 may comprise any type of conventional load sensor. Preferably, the load sensing device 110 comprises a strain sensor and/or a torque sensor.

Such sensors are configured to detect a load in the form of a torque or strain on a component by means of measuring of a current passing through a load sensing thread.

For example, the torque sensor may comprise one or more strain gauges applied to the balancing shaft, said strain gauges generating an electric signal indicative of the torque exerted on the balancing shaft 73 by the one or more balancing springs 71, 72.

The load data may further be utilized for the control of different aspects of the overhead door arrangement 10.

Hence, the controller 120 may be configured to cause control of the overhead door arrangement 10 based on the load data. Thereby, the operation of the overhead door arrangement 10 may be adapted based on the load data in order to avoid the overhead door arrangement 10 operating during conditions where the counter balancing mechanism is not properly tensioned.

Referencing FIG. 3, the controller 120 may be configured to be operatively connected to a door control unit 29. The operating system 20 may comprise the door control unit 29. The door control unit 29 is configured to control the at least one motor 28.

The overhead door arrangement 10 may further comprise a user interface 170. The user interface 170 may be operatively connected to the door control unit 29. The user interface may comprise an indicating device for providing an indication to a user. Such an indicating device may for example be a display configured to display an indication to a user, a lighting device configured to provide an indication to a user by means of a light signal, a speaker device configured to provide an audible indication to user.

As depicted in FIG. 3, an overhead door system 1000 may be provided. The overhead door system 1000 may comprise the monitoring system 100 and the overhead door arrangement 10. Preferably, the door control unit 29 and the controller 120 may be comprised in a door control system 1050 of the overhead door system. Such a door control system 1050 may be configured to control the overhead door system 1000.

The controller 120 may be configured to cause control of the overhead door arrangement 10 based on the load data by means of the door control system 1050. The door control system 1050 may thus be configured to control the overhead door arrangement 10 based on the load data obtained from the load sensing device 110 by the controller 120.

In one embodiment, the controller 120 is configured to cause operation of the operating system 20. Additionally or alternatively, the controller 120 is configured to cause transmission of tension indicating data to the user interface 170 of the overhead door arrangement 10 for providing an indication to a user.

The controller 120 may be configured to determine a tension indication value based on the load data. The tension indication value may be a comparable value which may be compared to a reference value in order to detect when the counter balancing mechanism is not properly tensioned. The tension indication value may thus be considered a value indicative of the torque provided by the counterbalancing mechanism.

In one embodiment, the tension indicating value may be a tension indicating signal current obtained from the load sensing device. The tension indicating signal current may be compared to a reference current value to identify an improper tension condition, wherein the torque provided by the counter balancing mechanism is outside a reference threshold.

The tension indication value may be utilized for the control of the operation of the overhead door arrangement 10. Thus, the door control system 1050 may be configured to control the overhead door arrangement 10 based on the tension indication value.

In one embodiment, the controller 120 is configured to cause operation of the overhead door arrangement 10 in response to the tension indication value exceeding an upper reference threshold. Additionally or alternatively, the controller 120 may be configured to cause operation of the overhead door arrangement 10 in response to the tension indication value being below a lower reference tension threshold. Hence, the overhead door arrangement may be controlled in response to the tension of the counter balancing mechanism being outside a suitable interval, whereby the risks associated with having an improperly tensioned counter balancing mechanism can be mitigated.

In one embodiment, the controller 120 is configured to cause the operating system 20 to stop movement of the door leaf 11 in response to the tension indication value exceeding the upper reference tension threshold. Additionally or alternatively, the controller 120 may be configured to cause the operating system 20 to stop movement of the door leaf 11 in response to the tension indication value being below the lower reference tension threshold. Thereby, the operation of the door may be terminated if it is determined that the counter balancing mechanism is improperly tensioned, mitigating the risk for accidents and damage to the overhead door arrangement.

The load captured by the load sensing device may vary depending on the position of the door leaf. Hence, in order to further increase the precision and allow for the monitoring system to identify an improperly tensioned counter balancing mechanism regardless of the position of the door leaf, the monitoring system may further take positional data in account.

Thus, the controller 120 may be configured to obtain positional data acquired by a position sensing device 140. The overhead door arrangement 10 may hence comprise the position sensing device 140. The position sensing device 140 of the overhead door arrangement 10 may be configured to acquire positional data associated with the position of the door leaf 11. The controller 120 may be configured to cause operation of the overhead door arrangement 10 based on the load data and the positional data.

The position sensing device 140 may be any conventional position sensing device suitable for this application. For example, the position sensing device 140 may be an encoder. The encoder may be connected to the at least one motor 28 for monitoring the position of the door leaf 11. The encoder may be configured to monitor the rotation of a shaft connected to the motor 28.

In one embodiment, the position sensing device may be operatively connected to the door control unit 29.

The controller 120 may be configured to assign the tension indication value to a corresponding position of the door leaf 11. The upper reference tension threshold may be associated with a corresponding reference position of the door leaf 11. Additionally or alternatively, the lower reference tension threshold may be associated with a corresponding reference position of the door leaf 11.

The tension indication value and the detected position may be compared with a reference tension threshold and a corresponding reference position. Thus, the reference tension threshold and the corresponding reference position may form a reference data pair.

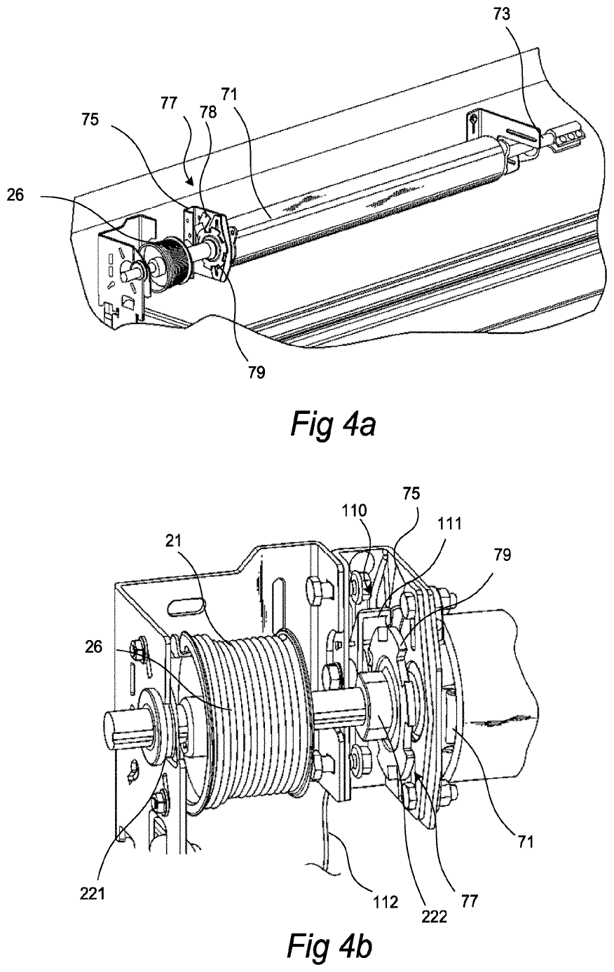

Upon comparison between the data pairs and in response to it being determined that the tension indication value exceeds or falls below the reference tension threshold, the controller 120 may cause control of the overhead door arrangement 10 accordingly. Turning to FIG. 4a-b, the counterbalancing mechanism is depicted in further detail.

As aforementioned, the balancing shaft 73 is connected to the door leaf 11. The balancing shaft 73 rotates in response to movement of the door leaf 11. Hence, upon lifting and lowering of the door leaf 11, the balancing shaft 73 rotates accordingly.

The one or more balancing springs 71, 72 are connected to the balancing shaft 73. Further, the one or more balancing springs 71, 72 are adapted to be connected to a fixed structure, i.e. a fix structure separate from the movable door leaf 11.

The balancing shaft 73 may be rotatably mounted in a balancing shaft bracket 75. The load sensing device 110 may be adapted to be mounted to said balancing shaft bracket 75. In one embodiment, the balancing spring 71, 72 is fixed to the balancing shaft bracket 75. In one embodiment, a first balancing spring 71 is fixed to a first balancing shaft bracket and a second balancing spring 72 is fixed to a second balancing shaft bracket.

The balancing shaft bracket 75 may comprise a balancing spring break protection mechanism 77. Balancing spring break mechanisms are commonly used in the field in order to ensure that the door leaf 11 does not fall down in case the balancing springs breaks.

The balancing spring break mechanism 77 may be adapted to prevent rotation of the balancing shaft 73 if the one or more balancing springs 71, 72 break. The load sensing device 110 may be adapted to be mounted to the balancing spring break protection mechanism 77. This allows for easier mounting compared to other plausible but less preferable options such as having the load sensing device mounted directly in relation to the balancing shaft or on a separate bracket. It may thus be envisioned that the load sensing device may be mounted in a number of ways available to the skilled person.

As the skilled person is aware, a balancing spring break protection mechanism may be designed in multiple ways. In the depicted example, the balancing spring break protection mechanism 77 comprises a ratchet wheel 79 connected to the balancing shaft 73. The ratchet wheel 79 may be fixedly connected to the balancing shaft 73 such that the ratchet wheel 79 rotates together with the balancing shaft 73. The balancing bring break protection mechanism 77 further comprises a locking element 78 which may be in the form of a pawl. The locking element 78 is movable between a braking position and a non-braking position. In the braking position, the locking element 78 engages the ratchet wheel 79 preventing rotation of said ratchet wheel 79 and thereby the balancing shaft 73. In the non-locking position, the locking element 78 is disengaged from the ratchet wheel 79 allowing rotation of said ratchet wheel 79 and thereby the balancing shaft 73.

The balancing spring break protection mechanism 77 may be adapted to receive a connecting member (not shown) of the counter balancing mechanism 70. The connecting member is mounted to the counter balancing spring 71, 72. Upon rotation of the connecting member the connecting member may engage the locking element 78 causing the locking element 78 to move from the non-locking position to the locking position. The connecting member may extend through an aperture of the balancing spring break protection mechanism 77.

Further referencing FIG. 4a-b, the overhead door arrangement may comprise a first balancing spring 71 and a second balancing spring 72. The first balancing spring 72 may be adapted to be connected to a first spring break protection mechanism and the second balancing spring 72 may be adapted to be connected to a second spring break protection mechanism.

The first balancing spring 71 may be adapted to be connected to a first spring break protection mechanism arranged on a first vertical side of the overhead door arrangement 10. The second balancing spring 72 may be adapted to be connected to a second spring break protection mechanism arranged on a second vertical side of the overhead door arrangement 10.

In the depicted example, the load sensing device 110 is operatively connected to the controller by means of a sensor cable 112. It may however be envisioned that the load sensing device 110 is wirelessly connected to the controller.

It may thus be envisioned that the monitoring system 100 may comprise multiple load sensing devices 140. In one embodiment, a first load sensing device may be mounted to the first spring break protection mechanism and a second load sensing device may mounted to the second spring break protection mechanism.

In the case of the load sensing device 110 comprising a torque sensor, e.g. a rotary torque sensor, the load sensing device 110 may be adapted to be arranged between the balancing shaft 73 and the door leaf 11. In one embodiment, the torque sensor of the load sensing device 110 may be adapted to be arranged between the drive arrangement, for example in the form of the cable and cable drum, and the balancing shaft 73. The balancing shaft 73 may extend into an aperture of the torque sensor. The torque sensor may comprise one or more sensing elements 111 such as strain gauges for acquiring load data in the form of strain gauge data from the portion of the balancing shaft 73 extending into the aperture of the load sensing device.

In one embodiment, the load sensing device 110 is arranged in a bearing 221, 222 connected to the balancing shaft 73. Thereby a more space-efficient monitoring system may be achieved.

The overhead door arrangement may hence comprise at least one bearing 221, 222 connected to the balancing shaft. As depicted in FIG. 4b, a cable drum bearing 221 may be connected to a shaft portion driving the cable drum 26. The bearing 221 may be adapted to rotatably connect the cable drum 26 to a bracket or side frame. In one embodiment, the load sensing device 110 may be arranged in said cable drum bearing 221.

As further depicted in FIG. 4b, a spring break mechanism bearing 222 may be arranged in the balancing spring break protection mechanism 77. The spring break mechanism bearing 222 may be connected to a shaft portion forming a part of the spring break mechanism. The spring break mechanism bearing 222 may be adapted to rotatably connect said shaft portion to a bracket or housing of the spring break protection mechanism. In one embodiment, the load sensing device 110 may be arranged in said spring break mechanism bearing 222.

It may however be envisioned that a bearing may be arranged at any suitable position while being connected to the balancing shaft 73 (directly or indirectly) and enable a load sensing device to acquire the load data. Hence, the load sensing device advantageously may be arranged in said bearing for acquiring the load data associated with the counterbalancing torque provided by the counter balancing mechanism 70.

According to an aspect an overhead door system 1000 is provided. The overhead door system 1000 comprises the overhead door arrangement 10. The overhead door arrangement 10 comprises the door leaf 11. The door leaf 11 comprises the plurality of door panels 17a-f being movable between the vertical closed position and the horizontal, opened or overhead position within the side frame 16.

The overhead door arrangement 10 comprises an operating system 20. The movement is caused by the operating system 20 comprising the at least one motor 28 and the drive arrangement 25. The drive arrangement 25 is connected to the motor 28 and at least one of the door panels 17a-f.

The overhead door arrangement further comprises the counter balancing mechanism 70. The door leaf 11 is balanced by means of the counter balancing mechanism 70. The counter balancing mechanism 70 is connected to the door leaf 11 and comprises the balancing shaft 73 and one or more balancing springs 71, 72.

The overhead door system 1000 further comprises the monitoring system 100 according to any one of the previously described embodiments.

In one embodiment, the overhead door system 1000 may comprise the door control system 1050 configured to control the overhead door arrangement 10. The door control system 1050 may comprise the controller 120.

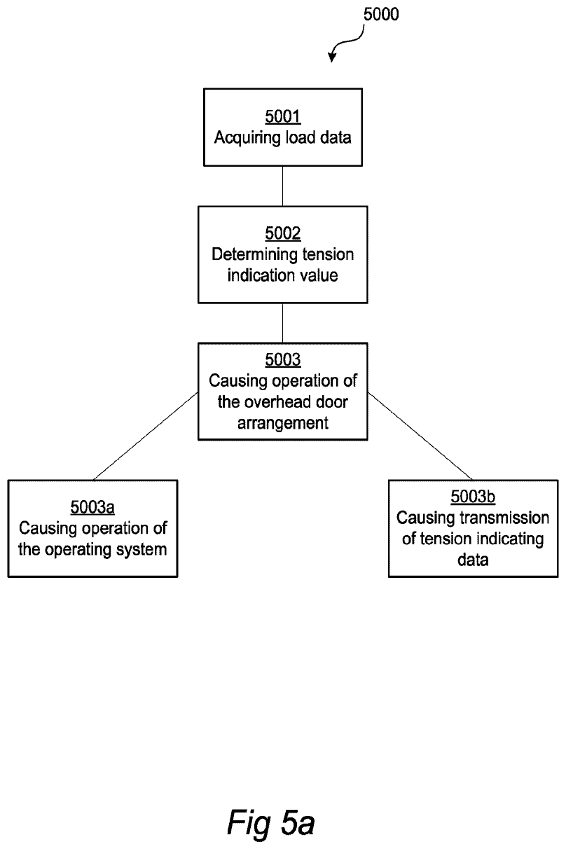

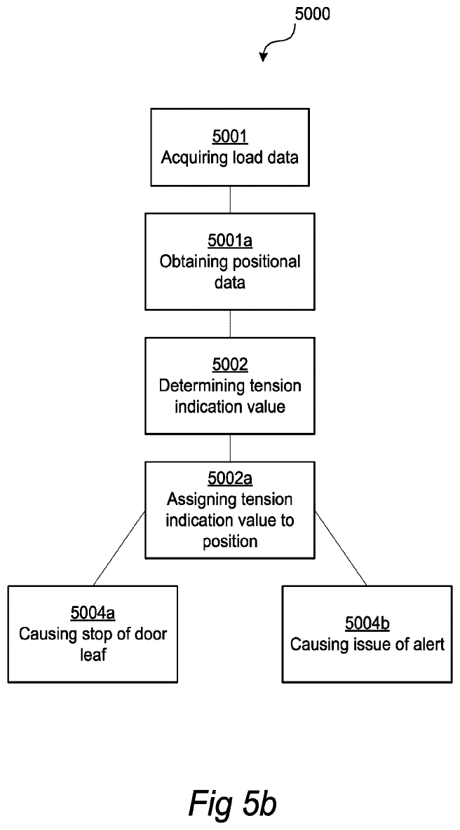

Turning to FIG. 5a-b, a method for operating the overhead door system 1000 is depicted.

The method may comprise acquiring 5001 the load data associated with the counterbalancing torque provided by the counter balancing mechanism 70 and causing 5003 operation of the overhead door arrangement 10 based on the load data.

As depicted in FIG. 5 a, the method may comprise causing 5003a operation of the operating system and/or causing 5003b transmission of tension indicating data to the user interface 170 of the overhead door arrangement 10 for providing an indication to a user. This may be performed based on the load data.

In one embodiment, the method comprises determining 5002 a tension indication value based on the load data.

In one embodiment, the method may comprise causing 5003 operation of the overhead door arrangement 10 in response to the tension indication value exceeding an upper reference tension threshold. In one embodiment, the method may comprise causing 5003 operation of the overhead door arrangement 10 in response to the tension indication value being below a lower reference tension threshold.

Turning to FIG. 5b, another embodiment of the method is depicted.

In one embodiment, the method may comprise causing 5004a a stop of the movement of the door leaf 11 in response to the tension indication value exceeding the upper reference tension threshold. In one embodiment, the method may comprise causing 5004a a stop of the movement of the door leaf 11 in response to the tension indication value being below a lower reference tension threshold.

In one embodiment, the method may comprise causing 5004b the user interface 170 to issue an alert in response to the tension indication value exceeding the upper reference tension threshold. In one embodiment, the method may comprise causing 5004b the user interface to issue an alert in response to the tension indication value being below the lower reference tension threshold.

The method depicted in FIG. 5b may implement the use of positional data.

Hence, the method may comprise obtaining 5001a positional data acquired by the position sensing device 140 of the overhead door arrangement 10 configured to acquire positional data associated with the position of the door leaf 11 and causing 5003 operation of the overhead door arrangement 10 based on the load data and the positional data.

In one embodiment, the method may comprise assigning 5002a the tension indication value to a corresponding position of the door leaf. The upper reference tension threshold may be associated with a corresponding reference position of the door leaf 11. The lower reference tension threshold may be associated with a corresponding reference position of the door leaf 11.

An example of the method according to one embodiment is depicted in FIG. 5b. At a time wherein the monitoring system is operating, the load sensing device acquires 5001 load data received by the controller 120. Further, the controller 120 obtains 5001a positional data from the position sensing device 140.

The controller then determines 5002 the tension indication value based on the load data and further assigns the tension indication value with the position of the door leaf in which the load data was acquired. Thus, the tension indication value and the detected position of the leaf may form a data pair.

The tension indication value and the detected position may then in the controller 120 and/or externally the monitoring system be compared with a reference tension threshold and a corresponding reference position. Thus, the reference tension threshold and the corresponding reference position may form a reference data pair.

Upon comparison between the data pairs and in response to it being determined that the tension indication value exceeds or falls below the reference tension threshold, the controller 120 may cause control of the overhead door arrangement 10 accordingly. For example, the controller 120 may send instruction data to the door operator system for causing 5004a stop of the door leaf 11. This may be performed by means of the door operator system stopping the motor 28 and/or applying a brake to the drive arrangement.

According to another example, the controller 102 may send instruction data to the user interface 170 for causing the user interface 170 to issue an alert. This may be performed by an indicating device of the user interface issuing a visible or audible alert. The invention has been described above in detail with reference to embodiments thereof. However, as is readily understood by those skilled in the art, other embodiments are equally possible within the scope of the present invention, as defined by the appended claims.

1. A monitoring system (100) for an overhead door arrangement (10), wherein the overhead door arrangement (10) comprises a door leaf (11), comprising a plurality of door panels (17a-f), being movable between a vertical closed position and a horizontal, opened or overhead position within a side frame (16), wherein the movement is caused by an operating system (20) comprising at least one motor (28) and a drive arrangement (25) connected to the motor (28) and at least one of the door panels (17a-f), and wherein the door leaf (11) is balanced by means of a counter balancing mechanism (70) connected to the door leaf (11) and comprising a balancing shaft (73) and one or more balancing springs (71, 72),
wherein the monitoring system (100) comprises:
a controller (120),
a load sensing device (110) operatively connected to the controller (120) and configured to acquire load data associated with the counterbalancing torque provided by the counter balancing mechanism (70), whereby the controller (120) is configured to obtain said load data.

2. The monitoring system (100) according to claim 1, wherein the load sensing device (110) comprises a strain sensor and/or a torque sensor.

3. The monitoring system (100) according to claim 2, wherein the balancing shaft (73) is rotatably mounted in a balancing shaft bracket (75) and the load sensing device (110) is adapted to be mounted to said balancing shaft bracket (75).

4. The monitoring system (100) according to claim 3, wherein the balancing shaft bracket (75) comprises a balancing spring break protection mechanism (77) and the load sensing device (110) is adapted to be mounted to said balancing spring break protection mechanism (77).

5. The monitoring system (100) according to claim 1, wherein the controller (120) is configured to cause control of the overhead door arrangement (10) based on said load data.

6. The monitoring system (100) according to claim 5, wherein the controller (120) is configured to, based on the load data, cause operation of the operating system (20) and/or transmission of tension indicating data to a user interface (170) of the overhead door arrangement (10) for providing an indication to a user.

7. The monitoring system (100) according to claim 1, wherein the controller (120) is configured to determine a tension indication value based on the load data.

8. The monitoring system (100) according to claim 7, wherein the controller (120) is configured to cause operation of the overhead door arrangement (10) in response to the tension indication value exceeding an upper reference tension threshold and/or being below a lower reference tension threshold.

9. The monitoring system (100) according to claim 8, wherein the controller (120) is configured to cause the operating system (20) to stop movement of the door leaf (11) in response to the tension indication value exceeding the upper reference tension threshold and/or being below the lower reference tension threshold.

10. The monitoring system (100) according to claim 8, wherein the controller (120) is configured to cause [[the]] a user interface (170) to issue an alert to a user in response to the tension indication value exceeding the upper reference tension threshold and/or being below the lower reference tension threshold.

11. The monitoring system (100) according to claim 7, wherein the controller (120) is configured to obtain positional data acquired by a position sensing device (140) of the overhead door arrangement (10) configured to acquire positional data associated with the position of the door leaf (11) and wherein the controller (120) is configured to cause operation of the overhead door arrangement (10) based on the load data and the positional data.

12. The monitoring system (100) according to claim 11, wherein the controller (120) is configured to assign the tension indication value to a corresponding position of the door leaf (11) and the upper reference tension threshold and/or the lower reference tension threshold is associated with a corresponding reference position of the door leaf (11).

13. The monitoring system (100) according to claim 1, wherein the load sensing device (110) is arranged in a bearing (221, 222) connected to the balancing shaft (73).

14. An overhead door system (1000) comprising:
an overhead door arrangement (10), wherein the overhead door arrangement (10) comprises a door leaf (11) comprising a plurality of door panels (17a-f) being movable between a vertical closed position and a horizontal, opened or overhead position within a side frame (16) and an operating system (20), wherein the movement is caused by the operating system (20) comprising at least one motor (28) and a drive arrangement (25) connected to the motor (28) and at least one of the door panels (17a-f), the overhead door arrangement (10) further comprising a counter balancing mechanism (70), wherein the door leaf (11) is balanced by means of the counter balancing mechanism (70) and said counter balancing mechanism (70) is connected to the door leaf (11) and comprises a balancing shaft (73) and one or more balancing springs (71, 72), and
the monitoring system (100) according to claim 1.

15. A method (5000) for operating an overhead door system (1000),
wherein the overhead door system (1000) comprises:
an overhead door arrangement (10), wherein the overhead door arrangement comprises a door leaf (11) comprising a plurality of door panels (17a-f) being movable between a vertical closed position and a horizontal, opened or overhead position within a side frame (16) and an operating system, wherein the movement is caused by the operating system (20) comprising at least one motor (28) and a drive arrangement (25) connected to the motor (28) and at least one of the door panels (17a-f), the overhead door arrangement (10) further comprising a counter balancing mechanism (70), wherein the door leaf (11) is balanced by means of the counter balancing mechanism (70) and said counter balancing mechanism is connected to the door leaf (11) and comprises a balancing shaft (73) and one or more balancing springs (71, 72),
and a monitoring system (100), wherein the monitoring system (100) comprises a controller

(120) and a load sensing device (110) operatively connected to the controller (120) and configured to acquire load data associated with the counterbalancing torque provided by the counterbalancing mechanism (70), whereby the controller (120) is configured to obtain said load data,
wherein the method comprises:
acquiring (5001) load data associated with the counterbalancing torque provided by the counterbalancing mechanism (70), and
causing (5003) operation of the overhead door arrangement (10) based on said load data.

16. The method (5000) according to claim 15, further comprising:
causing (5003a) operation of the operating system and/or transmission (5003b) of tension indicating data to a user interface (170) of the overhead door arrangement (10) for providing an indication to a user.

17. The method (5000) according to claim 15, further comprising:
determining (5002) a tension indication value based on the load data.

18. The method (5000) according to claim 17, further comprising:
causing (5003) operation of the overhead door arrangement (10) in response to the tension indication value exceeding an upper reference tension threshold and/or being below a lower reference tension threshold.

19. The method (5000) according to claim 18, further comprising:
causing (5004a) a stop of the movement of the door leaf (11) in response to the tension indication value exceeding the upper reference tension threshold and/or being below a lower reference tension threshold.

20. The method according to claim 18, further comprising:
causing (5004b) the user interface (170) to issue an alert to a user in response to the tension indication value exceeding the upper reference tension threshold and/or being below the lower reference tension threshold.

21. The method (5000) according to claim 17, further comprising:
obtaining (5001a) positional data acquired by a position sensing device (140) of the overhead door arrangement (10) configured to acquire positional data associated with the position of the door leaf (11), and
causing (5003) operation of the overhead door arrangement (10) based on the load data and the positional data.

22. The method (5000) according to claim 21, further comprising:
assigning (5002a) the tension indication value to a corresponding position of the door leaf (11), whereby the upper reference tension threshold and/or the lower reference tension threshold is associated with a corresponding reference position of the door leaf (11).).
